(19) United States
(12) Patent Application Publication
(10) Pub. No.: US 2025/0290822 A1
(43) Pub. Date: Sep. 18, 2025

(54) METHOD AND DEVICE FOR LEAK DETECTION

(71) Applicant: Norden Machinery AB, Kalmar (SE)

(72) Inventors: Per FRIDOLFSSON, Kalmar (SE); Nicklas ERIKSSON, Färjestaden (SE)

(21) Appl. No.: 18/862,986

(22) PCT Filed: Jul. 5, 2023
(86) PCT No.: PCT/EP2023/068556

§ 371 Date: Nov. 5, 2024

(30) Foreign Application Priority Data
Jul. 8, 2022 (SE) 2250876-6

(51) Int. Cl. G01M 3/28

(52) U.S. Cl. CPC G01M 3/2846

(57) ABSTRACT

A leakage detecting device (1) arranged to detect leakage in a seal (23) of a tube (2), comprising a first tube pressure means (3) and a second tube pressure means (4) arranged to provide a predefined pressure to the tube, detection means arranged to detect a pressure change in the tube after the predefined pressure has been applied to the tube, an electronic control unit arranged to compare an initial applied pressure value to a second pressure value to determine if a pressure change has occurred, and to give a fault signal if a pressure change has occurred, where the leakage detecting device (1) comprises a first seal pressure means (16) and a second seal pressure means (17) arranged to be positioned at the seal (23) of the tube (2) when the seal pressure means (3, 4) applies a pressure to the tube (2).

### TECHNICAL FIELD

The invention relates to a method and a device for high speed testing for leakage in a container, such as a tube or another flexible container. Applications of this type are often used in the packaging industry and the invention is aimed at full production speed detection of the container or the seal in sealed packages containing a perishable product in the form of cosmetic, chemical or pharmaceutical products, toothpaste, a foodstuff or similar. The arrangement according to the invention allows for high speed, in-line testing of the quality of a seal on such a package, and of the tightness of the package itself.

### BACKGROUND ART

It is known to prolong and safeguard the shelf life of perishable products by modifying the atmosphere in the free space remaining in the package after filling the product. The most common gases used in a modified atmosphere package (MAP) are nitrogen, CO₂ and oxygen or mixtures thereof. Oxygen is mainly used for keeping fresh meat red or for controlling the ripening rate of fruit and vegetables, whereas nitrogen and CO₂ are used for reducing the ageing effects of oxygen and reducing aerobic growth of micro-organisms in a multitude of products.

The packaging material in MAPs can be any essentially gas tight material including plastic film or coating, film coated paper and thin metal foils.

A leak in the package due to production errors or from later damage will result in at least a partial loss of the modified atmosphere and the predicted shelf life may be shortened. A further disadvantage of a leak is that the product may escape the package and contaminate the surrounding.

A common cause of leakage of a plastic tube is product residues or splashes deposited on the sealing surfaces prior to closure with welding. It is thus common to test the seal for leakage before the tube is delivered. Various leak testing arrangements have been presented and, in some cases, also used to prevent leaking packages from reaching the shop shelves.

A common limitation in many known methods is that they cannot perform 100% testing for leakage on individual packages at full production line speeds exceeding 30 packages per minute or more, i.e. having a cycle time of less than 2 seconds. This problem can be circumvented by either restricting testing to off-line spot testing or by making batch testing of a suitable number of packages in the same test cycle.

One possible way to increase testing capacity is to provide a number of parallel testing arrangements, each working at a lower speed but collectively matching the cycle time of the filling line.

EP 0894252 B1 discloses a leak testing method allegedly capable of performing individual package testing “very quickly, typically in about one second” indicating testing capacity of up to 60 packages per minute.

The method disclosed in EP 0894252 B1 employs diluted hydrogen as tracer gas. Hydrogen and helium are commonly used as tracer gases for leak testing. One problem with these gases is their relatively high diffusion rate through the thin polymer films and other packaging materials used as gas barriers in packaging materials. If the tracer gas diffuses through the non-leaking walls of the package there is a risk that the leak testing arrangement will detect a diffusion leakage that is not a package integrity problem. This problem can be overcome if the time between filling the gas and testing for leakage is sufficiently short so that the leak detection is performed before the gas has permeated through the barrier material. This break-through time is in the order of a few seconds to several minutes depending on the material used and on the thickness of the film.

EP 0894252 B1 employs a chamber in which the package is placed. The chamber is subsequently closed and a limited negative pressure is drawn. The document argues that this limited vacuum level, as compared to levels used in previous arrangements for gas testing, can be achieved quickly and with low cost means. The packages should be kept in the chamber for a dwell time claimed to be in the range of 0.5 to 60 seconds.

It is possible to partially reduce the time needed for some of these steps by letting these steps be carried out in parallel. It is for example evident that loading of the next package can be carried out in the same sequence as unloading the just tested package. Another example of such optimization is to allow for some of the sensor recovery time take place during the unloading/loading step.

However, even with the best practice, additional time is needed for decreasing the pressure in the chamber and, most of all, for true sensor recovery. The sensor recovery time is long and often not entirely predictable. This poses large restraints on the automation system in that the process cannot run at a constant speed.

The invention disclosed in EP 0894252 B1 can therefore not fulfil production speeds faster than 60 packages per minute that is requested in industry today. It is even doubtful if a speed of 30 packages per second can be reached.

Even though such testing systems can detect a small leakage in a tube or the like, they will not be able to detect the quality of the seal. In these systems, a low pressure is applied to the walls of the tube, such that the used test gas may escape if there is a leak in the seal. However, such a system will not detect the quality of the seal, i.e. if the seal is strong enough for normal handling. If a higher pressure is applied to the tube, e.g. in a shopping basket with other goods bearing on the tube, it is important that the seal is still tight and does not break. It is thus of advantage to test the tube by applying a higher pressure to the walls of the tube.

EP 2959282 B1 discloses a method in which an external pressure is applied to a tube-like package, and where a deformation of the weld seal of the tube-like package is detected. The deformation of the weld seam is detected by measuring the thickness of the seal. In one example, the thickness of the seal is measured at one point of the seal with a laser distance sensor. With this method, a defective seal may be detected if the complete seal is defective and peels. If only one side of the seal is defective, the defective seal may not be detected. Further, this method only detects a defective weld seam. Another defect of the tube-like package, such as a defect in the wall material or at the end region between the package wall and the seal, will not be detected. Further, the method is said to take more than 10 seconds to perform a leakage test, and is thus not suited for in-line testing with cycle times below 1 second.

In another known leakage system, a tube is pressed between two pressure members with a relatively high pressure, such as 8 bars or more. This test pressure is a predefined pressure set by the manufacturer or the customer. If the quality of the seal and the tube is acceptable, the seal and the tube will withstand this pressure. If the seal or the tube is faulty, the seal or tube will break with a burst and the content will escape the tube. This will at the same time contaminate the production line with the product such that the production line must stop for cleaning. One way of detecting that the content has escaped the tube is to use electrodes arranged above the seal and around the tube, where the content will close a circuit when the content hits the electrodes.

Such a system will detect a faulty seal or tube, but requires a stop of the production line when a faulty seal or tube is detected. There is thus room for an improved leakage detection system.

### DISCLOSURE OF INVENTION

An object of the invention is to provide an improved device for leakage detection. A further object is to provide an improved method for leakage detection.

The solution to the problem according to the invention is defined by the features of the independent claims related to the leakage detecting device and the method for detecting leakage. The other claims contain advantageous further developments of the leakage detecting device and the method for detecting leakage.

In a leakage detecting device arranged to detect leakage in a seal of a tube, comprising a first tube pressure means and a second tube pressure means arranged to apply a predefined pressure to the tube, a first seal pressure means and a second seal pressure means arranged to be positioned at the seal of the tube before the tube pressure means applies a pressure to the tube, the object of the invention is achieved in that the leakage detecting device comprises sensor means arranged to measure a signal indicative of the pressure in the tube when the first tube pressure means and the second tube pressure means apply the predefined pressure to the tube, and that the leakage detecting device comprises an electronic control unit arranged to determine if a pressure change has occurred in the tube based on input from the sensor means.

By this first embodiment of a leakage detecting device according to the invention, the leakage detecting device that can detect leakage in a seal of a tube without the risk of a substance escaping from the tube, is provided. If a seal is defective, the pressure applied to the tube will burst the seal. By positioning the seal pressure means at the seal, the seal pressure means will prevent the substance from spurting out of the tube if the seal is defective, which would otherwise cause the test equipment to be contaminated by the substance. Having the leakage detecting device arranged as an inline test equipment, the complete production line would otherwise have to be stopped for the cleaning of the test equipment. The leakage detective device will also be able to detect a defect in the tube itself, e.g. a defect in the wall material of the tube.

The first tube pressure means and the second tube pressure means are arranged to apply the predefined pressure to the tube by displacing the first tube pressure means and the second tube pressure means towards each other, when the tube is positioned between the first tube pressure means and the second tube pressure means.

In one example, the seal pressure means are arranged to press on the seal such that the seal pressure means bears on the seal before the tube pressure means applies the predefined pressure to the tube. In this example, the seal pressure means are arranged to press on the outer part or the upper part of the seal, e.g. on the upper half of the seal. In this way, part of the seal will be unsupported by the seal pressure means. The upper part that is pressed by the seal pressure means is e.g. 30 to 60% of the seal. This will leave the lower part of the seal unsupported, i.e. the part of the seal closest to the tube, and if the seal is defective, the lower part of the seal will open when the tube pressure means applies a pressure to the sides of the tube. When the seal opens, a pressure change in the tube will be detected and if the pressure change is larger than a predefined value, a fault signal indicating a defective seal or tube is issued. The pressure of the tube pressure means is released, the pressure of the seal pressure means is released, and the tube is discarded from the product flow. By releasing the pressure from the tube pressure means before the seal pressure means are released, there will be no pressure in the tube that will burst the rest of the defective seal when the seal pressure means is released.

In another example, the seal pressure means are arranged close to the seal, with a distance of between 0.1 mm to 1 mm from the seal before the tube pressure means apply the predefined pressure to the tube. In this example, the seal pressure means are arranged with a small distance to the seal. This small distance will allow a defective seal to open some, such that part of the sides of the seal bear on the seal pressure means and such that a small amount of air can escape through the opened seal from the tube. A further advantage with this method is that a bad seal may already be partly opened before it arrives at the seal pressure test station, e.g. due to previous handling or a bad sealing process. If such a bad seal is pressed on with the seal pressure means, no pressure change will occur since it will only be the seal pressure means that holds the seal together. By holding the seal pressure means at a small distance from the seal, such a bad seal can also be detected. This will cause a pressure change in the tube. In this example, the seal pressure means may be arranged over the complete seal, or at least over 60% of the seal. When the seal opens, the pressure change is detected by a sensor means that measures a signal representing the pressure in the tube. At the same time, the small distance between the seal and the seal pressure means will stop the substance from spurting out from the tube if the seal is defective. When the seal opens, the pressure change in the tube will be detected and if the pressure change is larger than a predefined value, a fault signal indicating a defective seal is issued. At the same time, the seal pressure means can be moved towards the seal in order to directly stop substance from escaping the tube, and the pressure applied by the tube pressure means is released. The seal pressure means are then withdrawn from the seal, and the tube is discarded from the product flow.

The tube pressure means and the seal pressure means are in one example arranged to move towards the tube and from the tube in a horizontal straight direction when the tube is standing up, but other moving directions such as a rotational movement is also possible. It is also possible to detect leakage on tubes that lay down on a conveyor belt, in which case the tube pressure means and the seal pressure means move in a direction that is perpendicular to the centre axis of the tube. Since the movement must be relatively fast, and since it is of advantage to be able to adjust the movement in dependency of the used tube, an electric movement means is preferred. An electric drive with a position sensor is fast and easy to control and to position in a predefined position.

In one example, the predefined pressure applied to the tube is between 1.5 to 4 bars.

In embodiments, the first tube pressure means and the second tube pressure means are arranged on a first drive belt driven by a first drive unit and/or the first seal pressure means and the second seal pressure means are arranged on a second drive belt driven by a second drive unit. The drive belts and the drive units are enabling efficient movements of the tube pressure means and/or the seal pressure means.

In embodiments, the first drive unit comprises a first motor and a first transmission and/or the second drive unit comprises a second motor and a second transmission.

In one example, the seal pressure means are arranged on a first drive belt driven by a first rotational motor and the tube pressure means are arranged on a second drive belt driven by a second rotational motor. Each motor is controlled independently of the other motor. By arranging one seal pressure means on a first part of the first drive belt, and the other seal pressure means on a second part of the first drive belt, a rotation of the motor will move the two seal pressure means either towards each other or from each other. In this way, the seal pressure means can apply a pressure to the tube in less than a second, and e.g. in 0.1 to 0,2 seconds. The release of the seal pressure means is equally fast. The same applies to the tube pressure means.

In other embodiments, the first tube pressure means is arranged on a linear actuator and the second tube pressure means is arranged on a linear actuator, and/or the first seal pressure means is arranged on a linear actuator and the second seal pressure means is arranged on a linear actuator.

In another example, the seal pressure means are arranged on two linear actuators and the tube pressure means are arranged on two linear actuators. The linear actuators will allow the two seal pressure means to move towards each other or from each other in a short time. In this way, the seal pressure means can move towards the seal in less than a second, and e.g. in 0.1 to 0.2 seconds. The release of the tube pressure means is equally fast. The same applies to the tube pressure means.

In other embodiments, the first tube pressure means is arranged on a pivotable bracket and the second tube pressure means is arranged on a pivotable bracket, and/or the first seal pressure means is arranged on a pivotable bracket and the second seal pressure means is arranged on a pivotable bracket.

In another example, the seal pressure means are arranged on two pivotable brackets and the tube pressure means are arranged on two pivotable brackets. The pivotable brackets are preferably driven by electric motors, either directly or through a transmission of some type, which will allow the two seal pressure means to move towards each other or from each other in a short time. In this way, the seal pressure means can move towards the seal in less than a second, and e.g. in 0.1 to 0.2 seconds. The release of the tube pressure means is equally fast. The same applies to the tube pressure means.

In embodiments, the sensor means is arranged to measure the drive current to the first drive unit and/or the sensor means is arranged to measure the drive current to the second drive unit. The drive current to the first drive unit measured by the sensor means may be used for providing the measured signal indicative of the pressure in the tube when the tube pressure means apply the predefined pressure to the tube. The electronic control unit is determining if a pressure change has occurred in the tube based on input from the sensor means, and the measured drive current to the first drive unit is used to estimate the pressure in the tube.

In one example, the drive current to the first drive unit is continuously measured by the sensor means during movement of the first tube pressure means and the second tube pressure means from an idle position to a pressure position in which the predetermined pressure is applied to the tube during a specific time, before returning to the idle position. If the drive current is not reaching a predetermined value, the tube is considered faulty. If the drive current rapidly decreases during movement of the first tube pressure means and the second tube pressure means to the pressure position, or during the specific time in the pressure position, the tube is considered faulty. Upon detection of a faulty tube, the first tube pressure means and the second tube pressure means may directly return to the idle position.

In embodiments, the sensor means is arranged to measure the movement of the first drive unit, and/or the sensor means is arranged to measure the movement of the second drive unit. In this way, the movement of the first drive unit measured by the sensor means may be used for providing the measured signal indicative of the pressure in the tube when the tube pressure means apply the predefined pressure to the tube. In one example, a predefined pressure is applied to the tube by the tube pressure means, and the exact positions of the first tube pressure means and second tube pressure means are detected. If the seal is correct, there will be no change in position of the tube pressure means. If a seal is not correct, the position of the tube pressure means will change slightly, and this change in position is detected by the sensor means.

The invention further relates to a method for detecting leakage in a seal of a tube by a leakage detecting device. The leakage detecting device comprises a first tube pressure means and a second tube pressure means, a first seal pressure means and a second seal pressure means, and sensor means. The method comprises the steps: positioning the tube between the first tube pressure means and the second tube pressure means, and positioning the seal between the first seal pressure means and the second seal pressure means; applying a predefined pressure to the tube by the first tube pressure means and the second tube pressure means; measuring a signal indicative of the pressure in the tube by the sensor means when the first tube pressure means and the second tube pressure means apply the predefined pressure to the tube; determining if a pressure change has occurred in the tube by an electronic control unit based on input from the sensor means.

In one embodiment, the method further comprises the step: applying the predefined pressure to the tube by displacing the first tube pressure means and the second tube pressure means towards each other.

In one embodiment, the method further comprises the step: issuing a fault signal if a pressure change is determined by the electronic control unit.

In one embodiment, the method further comprises the step: positioning the first seal pressure means and the second seal pressure means such that they bear on the seal of the tube.

In one embodiment, the method further comprises the step: positioning the first seal pressure means and the second seal pressure means at a distance of 0.1 to 1.0 mm from the seal of the tube.

In one embodiment, the method further comprises the step: applying the predefined pressure to the tube in a range between 1.5 to 4 bars.

In one example, the method for detecting leakage of a flexible tube having a welded seal, the steps of: placing seal pressure means at the seal of the tube; applying a predefined pressure to the tube with tube pressure means; measuring a signal indicative of the pressure in the tube with a sensor means; determining if there is a pressure change in the tube with a control unit after the predefined pressure to the tube has been applied; and if a pressure change is detected, issue a fault signal, are comprised.

By the inventive method, it is possible to detect a leakage in a tube having a welded seal without breaking the seal completely, which will prevent substance from the tube to contaminate the surrounding of the tube by spurting out of the tube. In this way, each individual seal of the tubes can be tested in the regular production flow, and a tube with a defective seal can be discarded immediately, either by stopping the production flow directly or without having to stop the production flow to clean the testing apparatus.

### BRIEF DESCRIPTION OF DRAWINGS

The invention will be described in greater detail in the following, with reference to the embodiments that are shown in the attached drawings, in which

FIG. 1 shows a view of a leakage detecting device according to the invention,

FIG. 2 shows a detail of a leakage detecting device before pressure is applied to a tube,

FIG. 3 shows a detail of a leakage detecting device when pressure is applied to a tube,

FIG. 4 shows a detail of a leakage detecting device when pressure is applied to a tube, and

FIG. 5 shows a flowchart of a method for detecting leakage of a flexible tube having a welded seal according to the invention.

### MODES FOR CARRYING OUT THE INVENTION

The embodiments of the invention with further developments described in the following are to be regarded only as examples and are in no way to limit the scope of the protection provided by the patent claims.

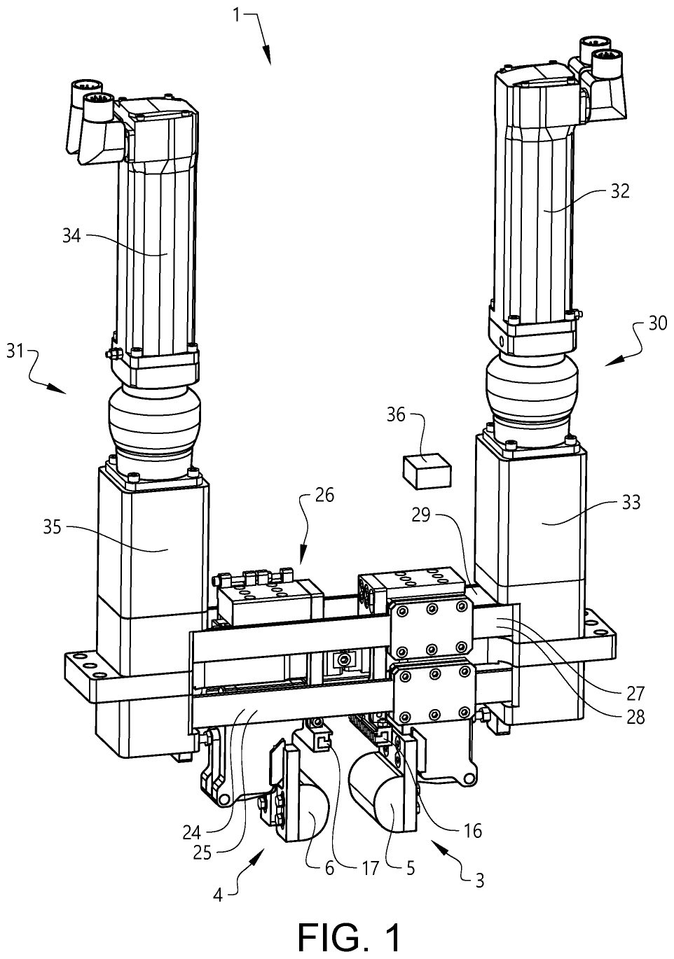

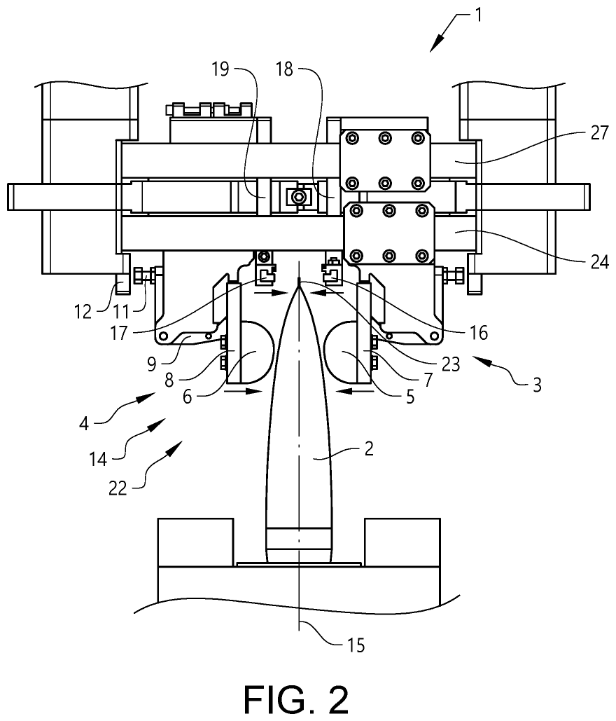

FIGS. 1 shows a view of a leakage detecting device, FIGS. 2 to 4 show details of the leakage detecting device, and FIG. 5 shows a flowchart of a method for leakage detecting. The leakage detecting device 1 according to the invention comprises a first tube pressure means 3 and a second tube pressure means 4 that are arranged to apply a pressure to a tube 2. The pressure may be applied to any position of the tube, but in the shown example, the pressure is applied to the upper half of the tube. Applying the pressure to the tube close to the seal will allow for a compact leakage detecting device that does not interfere with the tube flow. The first tube pressure means 3 comprises a first pressure pad 5 and the second tube pressure means 4 comprises a second pressure pad 6. The pressure pads are provided with a smooth surface and shape such that they will apply a pressure to the tube without damaging the tube surface. In the shown example, the pressure pads are semi-circular pads made from a rigid material that does not flex when a pressure is applied to the tube, but other shapes are also possible. The material may be plastic, rubber or metal.

The first pressure pad 5 is mounted to a first holding bracket 7 and the second pressure pad 6 is mounted to a second holding bracket 8. The holding brackets are attached to the tube pressure means in a removable manner, such that the pressure pads can easily be exchanged or replaced, such that the pressure pads can be exchanged to conform to the size of the used tube.

In the shown example, each tube pressure means is provided with a locking arrangement that will release the holding brackets of the pressure pads when the tube pressure means are positioned in a release position. A locking arrangement comprises a pivotable bracket 9 having a locking nose 10 arranged at the side of a holding bracket and an adjustable bearing member 11 that will bear on an end stop 12 in the release position. In the release position, the pivotable bracket will pivot such that the locking nose releases the holding bracket and such that the pressure pad can be removed. The holding brackets may be provided with magnets holding the holding brackets in place when the tube pressure means are in the release position. A spring holds the locking arrangement in the locking position.

The first and a second tube pressure means are provided with an idle position 14 and a pressure position 13. In the idle position 14, the distance between the pressure pads is larger than the width of a tube, such that a tube can be positioned between the pressure pads without interfering with the pressure pads. In the pressure position 13, the pressure pads applies a predefined pressure to the tube, such that the pressure in the tube is increased. The pressure is applied perpendicular to the centre axis 15 of the tube 2. The applied pressure must be high enough to detect a faulty weld of the tube 2 or a defect in the tube. A suitable pressure is e.g. between 1.5 to 4 bars, or between 2 to 3 bars, depending on the size of the tube. The exact applied pressure is not important, since it is a detected pressure change that indicates if the weld is defective. A too low pressure will however not test the seal sufficiently, and will further deform a faulty weld too slow.

The leakage detecting device is further provided with a first seal pressure means 16 and a second seal pressure means 17. The first seal pressure means is mounted on a first arm 18 and the second seal pressure means is mounted on a second arm 19. Each seal pressure means may be provided with a somewhat resilient surface, such as soft plastic or rubber, such that the weld will not be damaged when the seal pressure means bears on the weld. The seal pressure means are provided with a seal bearing position 20, a seal pressure position 21 and a seal idle position 22. In the seal bearing position, the seal pressure means bear on the weld with a low force. In the seal pressure position, the seal pressure means are positioned close to the weld, with a small distance. In the seal idle position, the seal pressure means are positioned apart from each other such that a tube can be positioned between the seal pressure means without interfering with the seal pressure means.

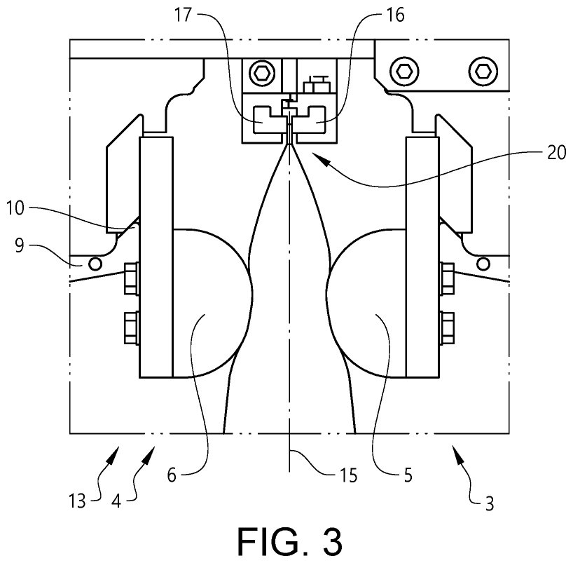

In a first example, shown in FIG. 3, the first and a second seal pressure means 16, 17 are positioned in the seal bearing position 20 such that they bear on the seal 23 of the tube 2. In this example, the seal pressure means bear on the upper half of the seal, such that at least 40% of the seal is free. When the seal pressure means bears on the seal, the first and the second tube pressure means 3, 4 are positioned in the tube pressure position 13 such that they apply a pressure to the tube. When the pressure pads bear on the tube, sensor means measures a signal indicative of the pressure in the tube and an electronic control unit (ECU) 36 is used to determine if there is a pressure change in the tube based on the measured signal. In one example, a signal indicative of the pressure in the tube or the applied pressure to the tube is measured. An estimated pressure value can be determined e.g. by measuring the force applied to the tube, by measuring a drive current used to apply the force to the tube, or by measuring a position of the drive unit. The system will measure several values representing the pressure in the tube, and will use two or more values to determine if there is a pressure change in the tube.

In one example, a first value is measured and is compared with a second value. If the difference between the first value and the second value differs more than a predefined amount, it is determined that a pressure change has occurred. In another example, several values are measured and the slope of the curve is used to determine if a pressure change has occurred. If the slope is steeper than a predefined value, it is determined that a pressure change has occurred.

If the seal is correct, the pressure in the tube will remain the same and the ECU will determine that a pressure change has not occurred. In this case, the seal of the tube is approved. The tube pressure means are moved to the tube idle position and the seal pressure means are moved to the seal idle position, the tube is forwarded in the tube flow and a new tube is positioned for leakage testing.

If the seal is faulty, the lower half of the seal will burst open, which will decrease the pressure in the tube slightly since the total inner volume of the tube will increase somewhat. This pressure change is detected by the ECU and the tube is not approved. The tube pressure means are moved to the tube idle position, thereafter the seal pressure means are moved to the seal idle position and the tube is discarded from the tube flow. By applying a pressure to the seal during the leakage test, the complete seal will not be able to burst open, which prevents the substance in the tube to spurt out.

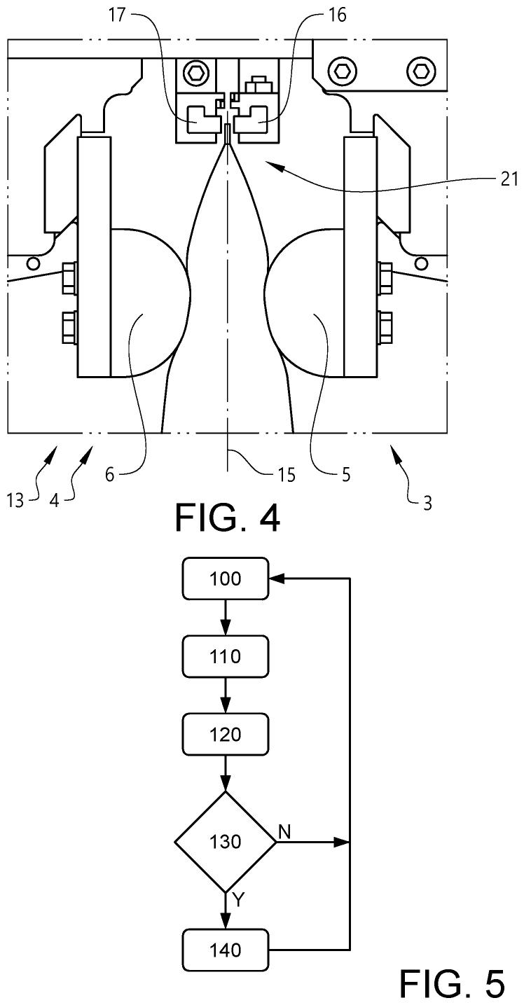

In a second example, shown in FIG. 4, the first and a second seal pressure means 16, 17 are positioned in the seal pressure position 21. In this example, the seal pressure means will not touch the seal but will be positioned close to the seal, with a distance between 0.1 to 1.0 mm from the seal 23 of the tube 2. In this example, the seal pressure means may be arranged at the same height as the seal, such that they cover most of or the complete seal. When the seal pressure means are positioned in the seal pressure position 21, the first and the second tube pressure means 3, 4 are positioned in the tube pressure position 13 such that they apply a pressure to the tube. When the pressure pads bear on the tube, the initial pressure in the tube may be estimated and may be used as a default pressure value. The system will measure at least one following value representing the pressure in the tube in order to determine if there is a pressure change in the tube.

If the seal is correct, the pressure in the tube will remain the same and the ECU will not detect a pressure change. In this case, the seal of the tube is approved. The tube pressure means are moved to the tube idle position and the seal pressure means are moved to the seal idle position, the tube is forwarded in the tube flow and a new tube is positioned for leakage testing.

If the seal is faulty, part of the seal will open, such that some air can escape out of the seal and such that the pressure in the tube decreases. Since the seal pressure means are positioned close to the seal, the seal will not burst open completely. Instead, a small opening will be formed, through which the pressure can slowly escape, but which prevents the substance in the tube to escape. When the opening releases some of the gas in the tube, the pressure decreases slightly. This pressure change is detected by the ECU, a fault signal is issued and the tube is not approved. At the same time, the seal pressure means are preferably moved towards the seal in order to directly stop substance from escaping the tube and the tube pressure means are moved to the tube idle position in order to release the pressure applied on the tube. Thereafter the seal pressure means are moved to the seal idle position and the tube is discarded from the tube flow. By allowing the seal to open slightly such that a small amount of the gas in the tube can escape, the complete seal will not be able to burst open, which prevents the substance in the tube to spurt out. If the seal is very bad, e.g. if it is partly opened before it arrives at the seal pressure test station, the defective seal can also be detected by this method. For such a bad seal, when pressing directly on the seal with the seal pressure means, no pressure change will be detected since it is only the seal pressure means that holds the seal together. By allowing some air to escape the tube when pressure is applied to the tube, such a bad seal will also be detected and can be discarded.

In one example, the first and the second tube pressure means 3, 4 are arranged on a first drive belt 24 driven by a first drive unit 30. The first drive unit comprises a first motor 32 and a first transmission 33. The drive belt is preferably provided with teeth such that the belt will not slip on the drive wheel. The first drive belt runs on a drive wheel driven by the first motor through the first transmission and an idle wheel arranged at the second transmission. The first tube pressure means 3 is arranged on a first part 25 of the first drive belt, arranged at the front region in the shown example, and the second tube pressure means 4 is arranged on a second part 26 of the first drive belt, arranged at the rear region in the shown example. In this way, the tube pressure means will move in opposite directions when the drive motor rotates. When the first drive motor rotates in one direction, both tube pressure means will move inwards, towards the tube pressure position 13. When the first drive motor rotates in the other direction, both tube pressure means will move outwards, towards the tube idle position 14 or the tube release position.

The first and the second seal pressure means 16, 17 are arranged on a second drive belt 27 driven by a second drive unit 31. The second drive unit comprises a second motor 34 and a second transmission 35. The drive belt is preferably provided with teeth such that the belt will not slip on the drive wheel. The second drive belt runs on a drive wheel driven by the second motor through the second transmission and an idle wheel arranged at the first transmission. The first seal pressure means 16 is arranged on a first part 28 of the second drive belt, arranged at the front region in the shown example, and the second seal pressure means 17 is arranged on a second part 29 of the second drive belt, arranged at the rear region in the shown example. In this way, the seal pressure means will move in opposite directions when the drive motor rotates. When the second drive motor rotates in one direction, both seal pressure means will move inwards, towards the seal bearing position 20 or the seal pressure position 21. When the second drive motor rotates in the other direction, both seal pressure means will move outwards, towards the seal idle position 22.

The first and second tube pressure means and the first and second seal pressure means may also be moved in other ways. In one example, each pressure means is arranged on an individual linear actuator. In another example, each pressure means is arranged on a pivotable bracket arranged on an individual rotational axle driven by a motor. Other ways of moving the pressure means between a seal bearing position or a seal pressure position and a seal idle position are also possible.

The drive motors may be provided with some sort of position sensing means, e.g. an optical rotation sensor, that will detect the rotational position of the motor and thus the position of the pressure means. It is also possible to use linear position sensors or other types of position detection means in order to provide a feedback signal for the first and the second drive unit. It is also possible to measure the drive current to the drive unit in order to estimate the pressure in the tube.

The signal indicative of the pressure in the tube can be measured in several different ways. In one example, a predefined pressure is applied to the tube by the tube pressure means, and the exact position of the first and second tube pressure means is detected. If the seal is correct, there will be no change in position of the tube pressure means. If a seal is not correct, the position of the tube pressure means will change slightly, and this change in position is detected by the detection means. The position sensor may be a rotational sensor arranged in e.g. a drive motor, or may be a linear position sensor, e.g. an optical linear sensor.

In one example, the motor drive current used to hold the tube pressure means in position will change when the pressure in the tube changes. The drive current applied to the motor can be measured, and a change in motor current can be detected, indicating a change in the pressure in the tube. In another example, the rotational position of the motor is measured, and a change in rotational position is detected, which indicates a pressure change in the tube.

It is important that a detection of a pressure change in a tube is rapid. In one example, the throughput of the system is 100 tubes per minute, which gives a tube cycle time of 0.6 seconds. Thus, the positioning of the seal pressure means and the application of a pressure to the tube by the tube pressure means may take 0.1-0.2 seconds, the determination of a pressure change may take 0.2-0.4 seconds, and the release of the seal pressure means and the tube pressure means may take 0.1-0.2 seconds. If a seal is defective, the tube is discarded from the tube flow.

The determination of a pressure change is performed by an electronic control unit (ECU) that controls the movement of the tube pressure means and the seal pressure means and that receives measured values from sensor means that measures signals representing the pressure in the tube.

In the inventive method for detecting leakage of a flexible tube having a welded seal, the leakage detecting device will be able to detect a faulty seal without contaminating the production equipment, e.g. the tube filling machine or surrounding components with the substance from a tube.

In step 100, the seal pressure means are positioned at the seal of the tube, either bearing directly on the seal or by a small distance from the seal. The seal pressure means may be positioned to cover the complete seal, or to cover the upper part of the seal.

In step 110, a predefined pressure is applied to the tube with the tube pressure means. The predefined pressure is high enough to break a faulty seal, and may e.g. be between 1.5 to 4 bars.

In step 120, a signal indicative of the pressure in the tube is measured with a sensor means. The signal may be measured in different ways, e.g. by measuring the motor drive current of the tube pressure means or by measuring the rotational position of the motor of the tube pressure means.

In step 130, it is determined if there is a pressure change in the tube after the predefined pressure has been applied to the tube. The determination of a pressure change is made by an ECU based on the measured signal.

If no pressure change is determined, the tube is released and the method continues with a new tube in step 100.

In step 140, a fault signal is issued if a pressure change in the tube is determined. A pressure change in the tube indicates a faulty seal or a faulty tube. The fault signal may be used to control a device that discards the faulty tube from the tube flow. The fault signal may also be used to stop the tube filling system and to give a signal to an operator of the tube filling system. After the defective tube is discarded, or the tube filling system is restarted, the method may continue with step 100.

The invention is not to be regarded as being limited to the embodiments described above, a number of additional variants and modifications being possible within the scope of the subsequent patent claims.

### REFERENCE SIGNS

1: Leakage detecting device
2: Tube
3: First tube pressure means
4: Second tube pressure means
5: First pressure pad
6: Second pressure pad
7: First holding bracket
8: Second holding bracket
9: Pivotable bracket
10: Locking nose
11: Bearing member
12: End stop
13: Tube pressure position
14: Tube idle position
15: Central axis
16: First seal pressure means
17: Second seal pressure means
18: First arm
19: Second arm
20: Seal bearing position
21: Seal pressure position
22: Seal idle position
23: Seal
24: First drive belt
25: First part of first drive belt
26: Second part of first drive belt
27: Second drive belt
28: First part of second drive belt
29: Second part of second drive belt
30: First drive unit
31: Second drive unit
32: First motor
33: First transmission
34: Second motor
35: Second transmission
36: Electronic control unit

1. A leakage detecting device (1) arranged to detect leakage in a seal (23) of a tube (2), comprising a first tube pressure means (3) and a second tube pressure means (4) arranged to apply a predefined pressure to the tube (2), a first seal pressure means (16) and a second seal pressure means (17) arranged to be positioned at the seal (23) of the tube (2) before the first tube pressure means (3) and the second tube pressure means (4) apply the predefined pressure to the tube (2),
characterized in that the leakage detecting device (1) comprises sensor means arranged to measure a signal indicative of the pressure in the tube (2) when the first tube pressure means (3) and the second tube pressure means (4) apply the predefined pressure to the tube (2), wherein the leakage detecting device (1) comprises an electronic control unit (36) arranged to determine if a pressure change has occurred in the tube (2) based on input from the sensor means.

2. The leakage detecting device (1) according to claim 1,
wherein the first tube pressure means (3) and the second tube pressure means (4) are configured for applying the predefined pressure to the tube (2) by displacing the first tube pressure means (3) and the second tube pressure means (4) towards each other, when the tube (2) is positioned between the first tube pressure means (3) and the second tube pressure means (4).

3. The leakage detecting device (1) according to claim 1,
wherein the first seal pressure means (16) and the second seal pressure means (17) are arranged to bear on the seal (23) before the first tube pressure means (3) and the second tube pressure means (4) apply the predefined pressure to the tube (2).

4. The leakage detecting device (1) according to claim 3,
wherein the first seal pressure means (16) and the second seal pressure means (17) are arranged to bear on the outer part of the seal (23) before the first tube pressure means (3) and the second tube pressure means (4) apply the predefined pressure to the tube (2).

5. The leakage detecting device (1) according to claim 1,
wherein the first seal pressure means (16) and the second seal pressure means (17) are arranged to be positioned with a distance of between 0.1 mm to 1.0 mm from the seal (23) before the first tube pressure means (3) and the second tube pressure means (4) apply the predefined pressure to the tube (2).

6. The leakage detecting device (1) according to claim 1,
wherein the predefined pressure applied to the tube (2) is between 1.5 to 4 bars.

7. The leakage detecting device (1) according to claim 1,
wherein the first tube pressure means (3) and the second tube pressure means (4) are arranged on a first drive belt (24) driven by a first drive unit (30).

8. The leakage detecting device (1) according to claim 7,
wherein the first drive unit (30) comprises a first motor (32) and a first transmission (33).

9. The leakage detecting device (1) according to claim 7,
wherein the sensor means is arranged to measure the drive current to the first drive unit (30).

10. The leakage detecting device (1) according to claim 7,
wherein the sensor means is arranged to measure the movement of the first drive unit (30).

11. The leakage detecting device (1) according to claim 1,
wherein the first tube pressure means (3) is arranged on a linear actuator and the second tube pressure means (4) is arranged on a linear actuator, or
wherein the first tube pressure means (3) is arranged on a pivotable bracket and the second tube pressure means (4) is arranged on a pivotable bracket.

12. The leakage detecting device (1) according to claim 1,
wherein the first seal pressure means (16) and the second seal pressure means (17) are arranged on a second drive belt (27) driven by a second drive unit (31).

13. The leakage detecting device (1) according to claim 12,
wherein the second drive unit (31) comprises a second motor (34) and a second transmission (35).

14. The leakage detecting device (1) according to claim 12,
wherein the sensor means is arranged to measure the drive current to the second drive unit (31).

15. The leakage detecting device (1) according to claim 12,
wherein the sensor means is arranged to measure the movement of the second drive unit (31).

16. The leakage detecting device (1) according to claim 1,
wherein the first seal pressure means (16) is arranged on a linear actuator and the second seal pressure means (17) is arranged on a linear actuator, or
wherein the first seal pressure means (16) is arranged on a pivotable bracket and the second seal pressure means (17) is arranged on a pivotable bracket.

17. A method for detecting leakage in a seal (23) of a tube (2) by a leakage detecting device (1),
wherein the leakage detecting device (1) comprises a first tube pressure means (3) and a second tube pressure means (4), a first seal pressure means (16) and a second seal pressure means (17), and sensor means, wherein the method comprises the steps:
positioning the tube (2) between the first tube pressure means (3) and the second tube pressure means (4), and positioning the seal (23) between the first seal pressure means (16) and the second seal pressure means (17);
applying a predefined pressure to the tube (2) by the first tube pressure means (3) and the second tube pressure means (4);
measuring a signal indicative of the pressure in the tube (2) by the sensor means when the first tube pressure means (3) and the second tube pressure means (4) apply the predefined pressure to the tube (2);
determining if a pressure change has occurred in the tube (2) by an electronic control unit (36) based on input from the sensor means.

18. The method according to claim 17,
wherein the method further comprises the step: applying the predefined pressure to the tube (2) by displacing the first tube pressure means (3) and the second tube pressure means (4) towards each other.

19. The method according to claim 17,
wherein the method further comprises the step: issuing a fault signal if a pressure change is determined by the electronic control unit (36).

20. The method according to any of claims 17,
wherein the method further comprises the step: positioning the first seal pressure means (16) and the second seal pressure means (17) such that they bear on the seal (23) of the tube (2).

21. The method according to any of claims 17,
wherein the method further comprises the step: positioning the first seal pressure means (16) and the second seal pressure means (17) at a distance of 0.1 to 1.0 mm from the seal (23) of the tube (2).

22. The method according to any of claims 17,
wherein the method further comprises the step: applying the predefined pressure to the tube (2) in a range between 1.5 to 4 bars.

23. The method according to any of claims 17,
wherein the first tube pressure means (3) and the second tube pressure means (4) are arranged on a first drive belt (24) driven by a first drive unit (30), wherein the method comprises the step:
measuring the drive current to the first drive unit (30) by the sensor means when the first tube pressure means (3) and the second tube pressure means (4) apply the predefined pressure to the tube (2), wherein the measured drive current is indicative of the pressure in the tube (2), or
measuring the movement of the first drive unit (30) by the sensor means when the first tube pressure means (3) and the second tube pressure means (4) apply the predefined pressure to the tube (2), wherein the measured movement is indicative of the pressure in the tube (2).

24. The method according to any of claims 17,
wherein the method steps are performed in less than 1 second.
